(19) United States
(12) Patent Application Publication
(10) Pub. No.: US 2023/0256493 A1
(43) Pub. Date: Aug. 17, 2023

(54) Channel Letter Return and Trimcap Material Bending Machine

(71) Applicant: Computerized Cutters, Inc., Plano, TX (US)

(72) Inventors: Carl Ondracek, Plano, TX (US); William Oelklaus, Plano, TX (US); Gerardo Hernandez, Plano, TX (US)

(21) Appl. No.: 17/672,250

(22) Filed: Feb. 15, 2022

(51) Int. Cl. B21D 5/00; G09F 13/04

(52) U.S. Cl. CPC B21D 5/004; G09F 13/0404; G09F 13/0445

(57) ABSTRACT

A machine that may allow for notching, flanging if required, and bending of two different materials with different physical profiles and bending parameters and feeding requirements. The machine may process channel letter coil and/or trimcap material. Each type of material may be fed into the machine accurately, notched using one or more different notching methods, flanged, if required, and then bent in the proper shape given the various physical differences of channel letter coil and/or trimcap material. Accordingly, sign manufacturers may automatically notch and bend channel letter coil to produce letter returns and/or trimcap material used to attach the faces to the channel letters using just one single machine.

### FIELD OF THE DISCLOSURE

The present disclosure generally relates to bending of channel letter returns and/or channel letter trimcap materials, and more particularly to bending of channel letter returns and channel letter trimcap materials using the same machine.

### BACKGROUND

At most shopping strip malls, restaurants, and other stores, the main electrically illuminated sign, which is out front, typically displaying the name of the business, will be made of channel letters. Most channel letters are composed of a side body, or return, which is usually bent to shape from a coil of aluminum, a front face of the channel letter usually, cut out of a sheet of plastic, which is attached to the font of an aluminum side body return, and a back of the channel letter that can be made of metal or plastic, which is attached to the back of an aluminum side body return. The front face normally has a trimcap material (FIG. 5A) that is glued to the plastic front face (FIG. 5B). This trimcap material has a profile shape to it that allows it to be glued to the flat plastic front face to form a side edge that allows the plastic face, which now has a shape that resembles a shoe box lid (FIGS. 5C-5D), to be mounted to the front of the aluminum side body return by using screws to attach the face to the side body return. To mount the aluminum or plastic back to the aluminum side body return, the bottom ½ inch of the side body return is notched and bent about 90 degrees to itself to allow a mounting surface for the letter back to be mounted after the aluminum channel letter coil is bent to form the final shape of the side body return.

To fabricate the return, channel letter coil, normally aluminum, can be fed through a machine, notched, flanged, and bent to form the appropriate character using an automated bending machine. The return may also be fabricated on a machine without notching and flanging material prior to bending the channel letter coil. Channel letters can also include trimcap material, which has a different physical profile and different bending parameters compared to channel letter coil. Trimcap material can also be fed through a machine, notched, and bent using an automated bending machine. However, two separate and different machines have been needed to process the channel letter return material and the trimcap material. This requires purchasing or accessing two expensive machines to automatically process both materials.

### SUMMARY

Embodiments of the present disclosure may provide a channel letter return and/or trimcap material bending machine comprising: a computer control system that may receive desired configurations for a channel letter return and/or a trimcap material to selectively be formed on the same machine; one or more material feeding mechanisms controlled by the computer control system disposed along a path of travel of channel letter coil and/or trimcap material to be bent, wherein the one or more material feeding mechanisms can be coupled to an encoder or other measuring device, to accurately measure the channel letter coil and/or trimcap material, and the one or more material feeding mechanisms may selectively receive and process both the channel letter coil and/or the trimcap material; one or more notching stations which may include a punch located on a side of the path of travel of the channel letter coil or trimcap material to be notched and a die. The notching stations may further include a fluid cylinder or motor connected with the punch or die for driving the punch toward the die located on the other side of the path of travel to remove a section of the channel letter coil, and a mechanical cutting device, or punch and die for removing sections of the trimcap material disposed along the path of travel for notching the channel letter coil and/or trimcap material fed by the feeding mechanism along the path of travel as directed by the computer control system prior to bending the materials; a channel letter coil flanging station that will bend the bottom ¼ to ¾ of an inch portion of the channel letter coil to approximately 90 degrees to allow for the channel letter back to be mounted to the channel letter return, and a bending station disposed along the path of travel for selectively bending the channel letter coil and/or the trimcap material into the desired configuration as directed by the computer control system. The bending station may include one or more bending arms that may be movable across the path of travel of the channel letter coil and/or trimcap material to bend the channel letter coil and/or trimcap material into the desired shape. The machine also may include one or more cutting stations disposed along the path of travel of the channel letter coil and/or trimcap material for cutting the channel letter coil and/or trimcap material prior to removing the materials from the machine.

Other embodiments of the present disclosure may provide a channel letter return and trimcap material bending machine comprising: a computer control system that may receive a desired configuration for a channel letter return and/or a trimcap material to selectively be formed on the same machine; one or more material feeding mechanisms controlled by the computer control system disposed along a path of travel of channel letter coil and/or trimcap material to be bent, wherein the material feeding mechanisms may have a measuring device that may selectively receive and process both the channel letter coil and/or the trimcap material; one or more notching stations disposed along the path of travel for notching the channel letter coil and/or trimcap material fed by the feeding mechanism along the path of travel as directed by the computer control system; a channel letter coil flanging station for bending the bottom ¼ to ¾ of an inch portion of the channel letter coil, a bending station disposed along the path of travel for selectively bending the channel letter coil and/or the trimcap material into the desired configuration as directed by the computer control system, and possibly one or more cutting stations disposed along the path of travel of the channel letter coil and/or trimcap material for cutting the channel letter coil and/or trimcap material prior to removing the material from the machine, wherein the computer control system may determine where, what magnitude, and in what sequence the machine performs notching, flanging, and/or bending, and wherein the computer control system may control and adjust motors, hydraulic cylinders, and pneumatic cylinders associated with the material feeding mechanism, the notching station, flanging station, and the bending station depending on the channel return and/or trimcap material to be formed.

### BRIEF DESCRIPTION OF THE DRAWINGS

For a more complete understanding of this disclosure, reference is now made to the following description, taken in conjunction with the accompanying drawings, in which:

FIG. 1A depicts a schematic perspective view of a feed assembly according to an embodiment of the present disclosure;

FIGS. 1B-1D depict views of a feed assembly for channel letter coil and/or trimcap material according to embodiments of the present disclosure;

FIGS. 2A-2C depicts views of a notching assembly for trimcap material according to an embodiment of the present disclosure;

FIGS. 3A-3C depict notching for channel letter coil before, during, and after according to an embodiment of the present disclosure;

FIGS. 4A-4C depict flanging for channel letter coil before, during, and after according to an embodiment of the present disclosure;

FIG. 5A depicts a trimcap profile cross section;

FIG. 5B depicts a cross section showing a trimcap attached to a plastic face;

FIG. 5C depicts a top view of a trimcapped face; and

FIG. 5D depicts a bottom view of a trimcapped face.

### DETAILED DESCRIPTION

Embodiments of the present disclosure may provide a machine that may allow for notching, flanging (channel letter coil only) and bending of two different materials with different physical profiles and bending parameters and feeding requirements. More specifically, the machine may process both channel letter coil and trimcap material. Each type of material may be fed into the machine accurately, notched using one or more notching methods, and then bent into the proper shape given the various physical differences of channel letter return and trimcap material. Two different materials having different processing needs may be processed using the same machine. Accordingly, sign manufacturers may now automatically notch, flange and bend channel letter coil to produce letter returns and trimcap material used to attach the faces to the channel letters using just one single machine.

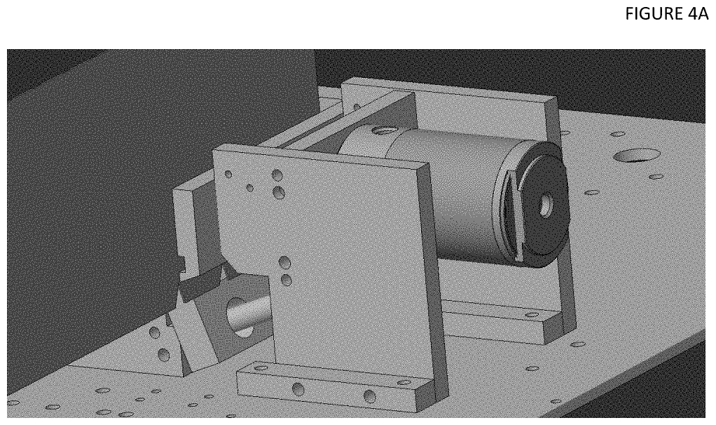

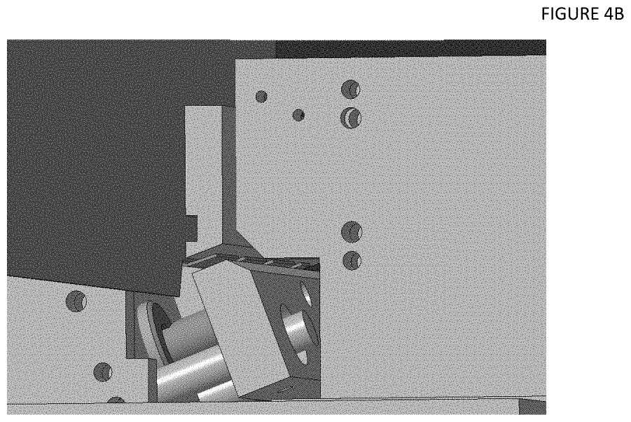

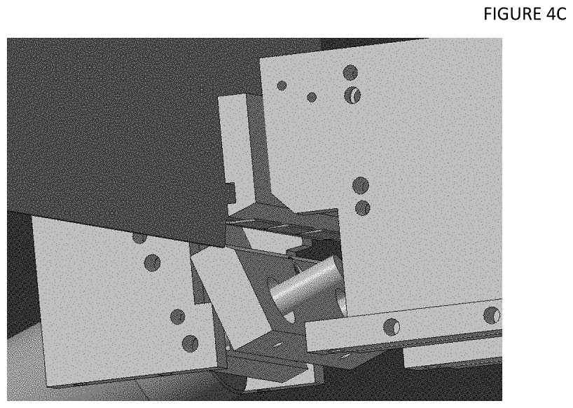

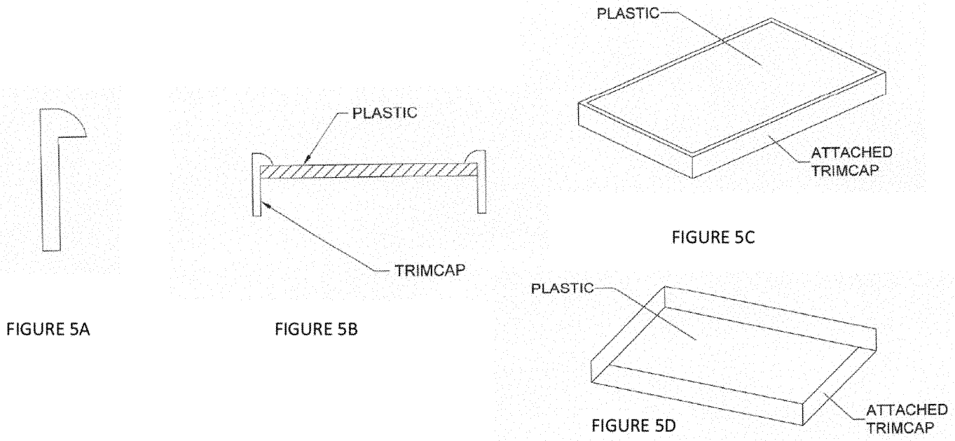

Embodiments of the present disclosure may provide a channel letter coil and trimcap material bending machine. The machine may include a computer control system for receiving a desired configuration for a channel letter coil and/or trimcap material to be formed. The machine also may include one or more material feeding mechanisms controlled and adjustable by the computer control system disposed along a path of travel of the material to be bent. One or more notching stations may be disposed along the path of travel for notching the trimcap material and/or the channel letter coil if desired, fed by the feeding mechanism along the path of travel. The machine may also include a channel letter coil flanging station disposed along the path of travel for bending the bottom ¼ to ¾ of an inch portion of the channel letter coil. FIGS. 4A-4C depict flanging before, during, and after according to an embodiment of the present disclosure. The machine also may include a bending station disposed along the path of travel for bending the material under the control of the computer control system into the desired configuration for the channel letter coil and/or trimcap material.

In an embodiment of the present disclosure, a roll of metal channel letter material or trimcap material may be positioned on the machine adjacent to one or more material feeding mechanisms. The material feeding mechanisms may be driven by a motorized feed roller, or other grip and move mechanisms that position the materials to be bent in the correct position to be processed.

An automatic channel letter return and trimcap material bending machine according to an embodiment of the present disclosure may include material loaded on the machine for supplying material to be bent. Material may be provided in a roll form, but it also may be supplied to the machine in strips of material in embodiments of the present disclosure. Material may travel through the machine along a material feed path that may be defined by the various material handling stations on the machine. A material feed path and/or feed assembly may automatically handle channel letter coil and/or trimcap material or be selectively adjusted depending on whether channel letter coil or trimcap material is being manipulated by the machine in embodiments of the present disclosure. These adjustments, if required, may be made using a computer control system associated with the machine or manually in embodiments of the present disclosure.

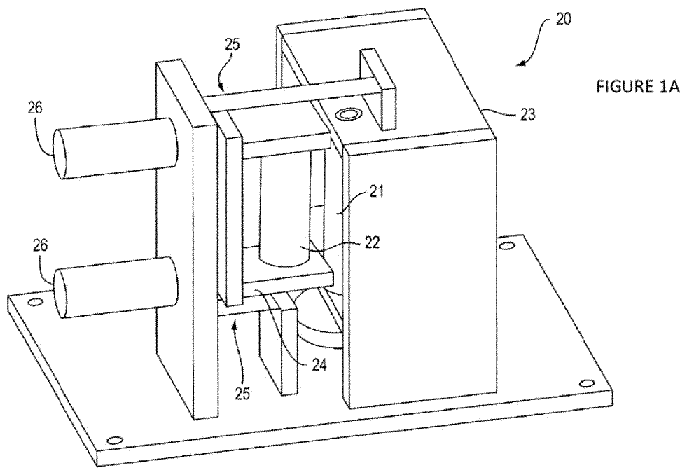

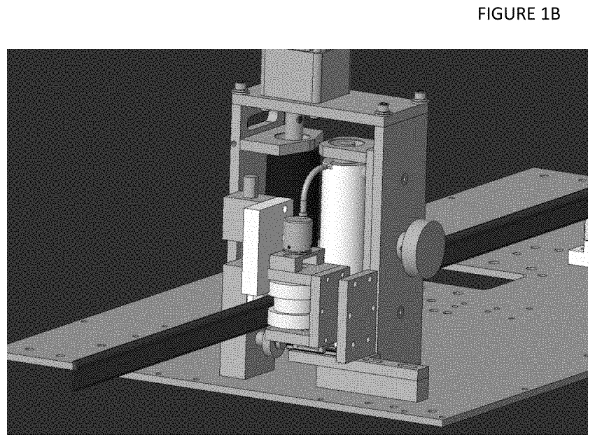

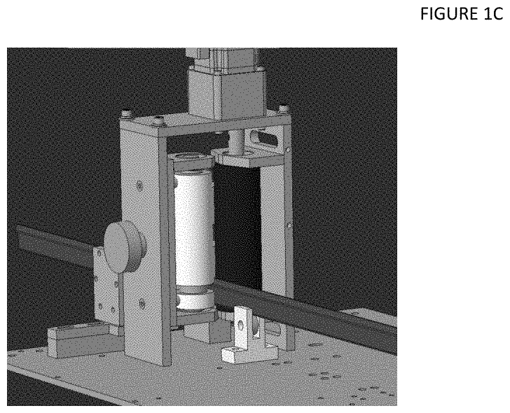

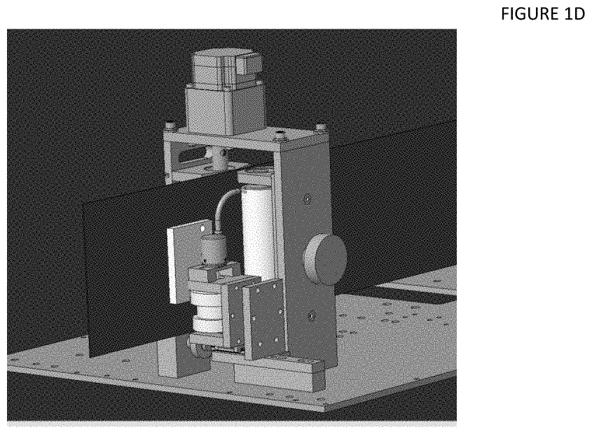

Material may be loaded into the machine at feed assembly. Feed 20 assembly is depicted in FIG. 1A. Feed assembly 20 may include driven roller 21 operated by a suitable motor and press roller 22. Driven roller 21 may be mounted in driven roller housing 23. Linear bearings 25 may be provided for supporting press roller housing 24 in linear movement toward and away from driven roller 21. Press roller 22 may be mounted on press roller housing 24 for movement toward and away from driven roller 21. When material is to be advanced by feed assembly 20, press roller housing 24 may be driven by fluid cylinders, or motors 26, which may be engaged with press roller housing 24, toward driven roller 21 such that press roller 22 and driven roller 21 sandwich the material therebetween. Press roller 22 thus forces the material against driven roller 21, and by operating driven roller 21 with the motor the material is advanced. Either press roller 22 or driven roller 21 can include one or more cutouts in the roller to allow the trimcap material to be fed through the roller. It should be appreciated that a computer control system may be utilized for adjusting the positioning of each type of material to be processed using the machine. FIGS. 1B-1D depict a feed assembly accommodating materials having different physical profiles and/or feeding requirements according to other embodiments of the present disclosure. Additional feed assemblies 20a, 20b may be provided along the material feed path of the machine in embodiments of the present disclosure. FIG. 1B shows the feeding station with the special wheel attached to the encoder for measuring the two different materials. It can press against the side of the aluminum channel letter coil. Because it has a material removed for the trimcap profile to fit into the roller, it can still be pressed up against the trimcap material to measure it. It is shown with trimcap material loaded on the machine. FIG. 1C shows the feeding station with the roller that is pressed against the materials for moving it. It can press against the side of the aluminum channel letter coil. Because it has a material removed for the trimcap profile to fit into the roller, it can still be pressed up against the trimcap material to move it. It is shown with trimcap material loaded on the machine.

The notching station notches the strip of material where appropriate. The step of notching may include forming the notch along an edge of the strip of material with the computer control system controlling the position of the material to be notched and control the punch and die of the notching station to the notch the material along the edge. As described herein, a notching station may further include a fluid cylinder or motor connected with the punch or die for driving the punch toward the die located on the other side of the path of travel to remove a section of the channel letter coil, and a mechanical cutting device, or punch and die for removing sections of the trimcap material.

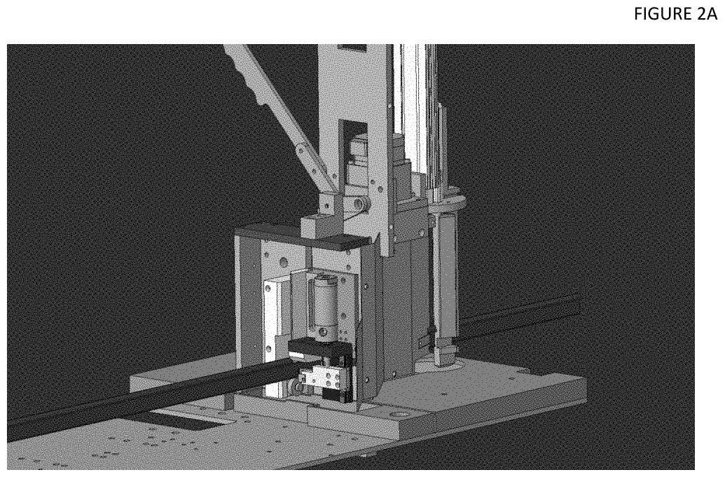

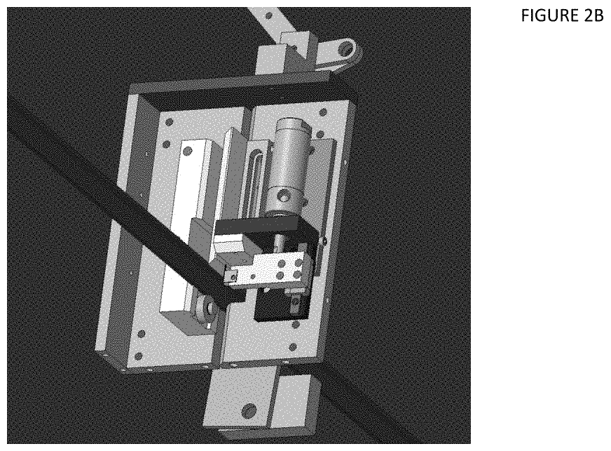

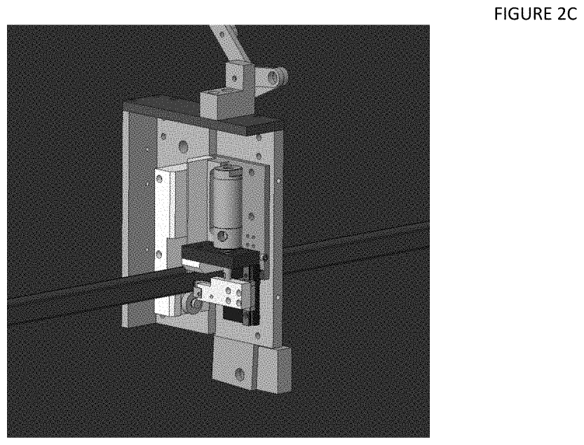

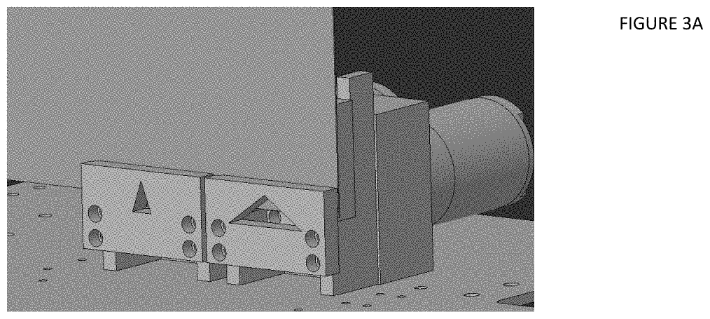

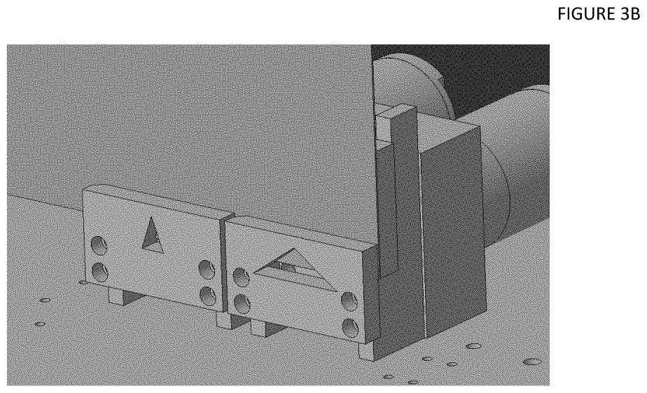

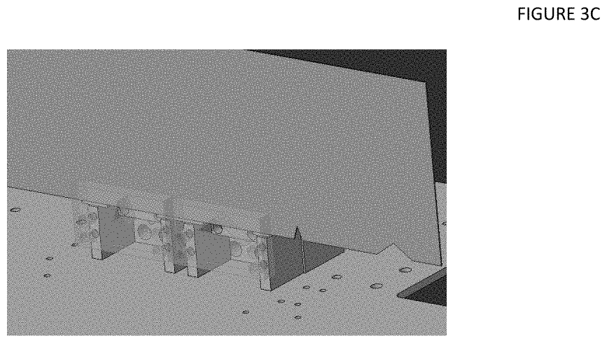

FIGS. 2A-2C depicts views of a notching assembly for trimcap material according to an embodiment of the present disclosure. The material may be fed along the material feed path(s) until it reaches the desired location in front of the notching assembly. Material may be fed to the notching assembly along a material feed path to align a portion of material 10a for notching. A notching assembly may include a punch and a die. FIGS. 3A-3C depict notching for channel letter coil before, during, and after according to an embodiment of the present disclosure.

A metal material can automatically be bent into a described configuration or shape such as corresponding to an outside skin, or return of a channel letter, or a trimcap material can automatically be bent into a described configuration or shape such as corresponding to the shape of the face of the channel letter so it can be attached to the face to form the front of the channel letter that can be attached to the channel letter return. The strip of material may be bent at the bending station into a desired configuration, with the bending station being controlled by the control computer. The bending station may include one or more bending arms that that can move perpendicular to the material and a movable bending arm that is movable across the path of travel of the material to bend the material against either the fixed support or the clamping support.

Operation of the machine according to embodiments of the present disclosure may be performed under the control of a computer control system. The computer control system may be programmed to receive data information concerning the type of material to be formed (i.e., channel letter coil and/or trimcap material), the type of shape to be bent, whether that shape corresponds to some character, a specific letter or any other shape which is programmed to be formed, and/or other profile characteristics. Numerical data may be converted by the computer control system into suitable commands for forming the appropriate shape.

A computer control system according to an embodiment of the present disclosure under the control of its software, and or a controller board, may operate the various electric motors employed with the systems, and through relays, may operate the various pneumatic and hydraulic cylinders. The software operated by the computer controlling the machine may read an exported file associated with the material to be formed. The software then may read in and store all detailed information for the lines and arcs describing the channel letter coil and/or trimcap material. The controller board may process this information to control the motors, hydraulic cylinders, and pneumatic cylinders of the machine to yield the correctly formed end product. The controller can determine the proper sequencing for controlling the feed rates and linear feed of the material into and throughout the machine. Thus, the control software may determine where, what magnitude, and in what sequence the machine must perform a move, notching operation, flanging operation or the bending operation (what direction of bend, and what angle) in embodiments of the present disclosure. Once the final product has been successfully formed, the controller may cut the material and then feed the material backwards through the machine and reestablish a starting “home” position for the material. At this point, the machine is then ready for the next part to be formed. Alternatively, material can be fed in the machine again to allow the machine to be ready to run the next part to be formed.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A channel letter return and trimcap material bending machine comprising:
a computer control system that receives one or more desired configurations for a channel letter return and/or a trimcap material to selectively be formed on the same machine;
one or more material feeding mechanisms controlled by the computer control system disposed along a path of travel of the channel letter coil and/or trimcap material to be bent, wherein the one or more material feeding mechanisms are capable of being coupled to a measuring device to measure the channel letter coil and/or trimcap material, and wherein the one or more material feeding mechanisms selectively receive and process the channel letter coil and/or the trimcap material;
one or more notching stations disposed along the path of travel for notching the channel letter coil and/or trimcap material fed by the feeding mechanism along the path of travel as directed by the computer control system;
a channel letter coil flanging station disposed along the path of travel for bending a bottom ¼ to ¾ of an inch portion of the channel letter coil to approximately 90 degrees to allow for a channel letter back to be mounted to the channel letter return; and
a bending station disposed along the path of travel for selectively bending the channel letter coil and/or the trimcap material into the desired configuration as directed by the computer control system.

2. The machine of claim 1, the bending station comprising:
one or more movable bending arms that is movable across the path of travel of the channel letter coil and/or trimcap material to bend the channel letter coil and/or trimcap material against a fixable support or clamp.

3. The machine of claim 1, the one or more notching stations comprising:
a punch located on a side of the path of travel of the channel letter coil and/or trimcap material to be notched and a die located on the other side of the path of travel.

4. The machine of claim 3, the one or more notching stations comprising:
a fluid cylinder or motor connected with the punch or die to drive the punch toward the die to remove a section of the channel letter coil and/or trimcap material.

5. The machine of claim 1, the one or more notching stations comprising:
a mechanical cutting device for removing material in the channel letter coil and/or trimcap material.

6. The machine of claim 1, the bending station comprising:
one or more bending arms to form the materials into a desired configuration, with the bending station being controlled by the control computer.

7. The machine of claim 1 further comprising:
one or more cutting stations disposed along the path of travel of the channel letter coil and/or trimcap material for cutting the channel letter coil and/or trimcap material prior to removing the material from the machine.

8. A channel letter return and trimcap material bending machine comprising:
a computer control system that receives a desired configuration for a channel return and/or a trimcap material to selectively be formed on the same machine;
one or more material feeding mechanisms controlled by the computer control system disposed along a path of travel of a channel letter coil and/or trimcap material to be bent;
one or more notching stations disposed along the path of travel for notching the channel letter coil and/or trimcap material fed by the feeding mechanism along the path of travel as directed by the computer control system;
a channel letter coil flanging station disposed along the path of travel for bending a bottom ¼ to ¾ of an inch portion of the channel letter coil;
a bending station disposed along the path of travel for selectively bending the channel letter coil and/or the trimcap material into the desired configuration as directed by the computer control system; and
one or more cutting stations disposed along the path of travel of the channel letter coil and/or trimcap material for cutting the channel letter coil and/or trimcap material prior to removing the material from the machine,
wherein the computer control system determines where, what magnitude, and in what sequence the machine performs notching, flanging, and/or bending, and
wherein the computer control system controls and adjusts motors, hydraulic cylinders, and pneumatic cylinders associated with the one or more material feeding mechanisms, the notching stations, the channel letter coil flanging station, and the bending station depending on the channel letter coil and/or trimcap material to be formed.

9. The machine of claim 8, the one or more material feeding mechanisms further comprising:
a measuring device that selectively receives and processes both the channel letter coil and/or the trimcap material.

10. A channel letter return and trimcap material bending machine comprising:
a computer control system that receives one or more desired configurations for a channel letter return and/or a trimcap material to selectively be formed on the same machine.
